(19) United States
(12) Patent Application Publication
(10) Pub. No.: US 2026/0149232 A1
(43) Pub. Date: May 28, 2026

(54) LASER CHAMBER, GAS LASER APPARATUS, AND ELECTRONIC DEVICE MANUFACTURING METHOD

(71) Applicant: Gigaphoton Inc., Tochigi (JP)

(72) Inventor: Takuya OGAWA, Tochigi (JP)

(73) Assignee: Gigaphoton Inc., Tochigi (JP)

(21) Appl. No.: 19/347,648

(22) Filed: Oct. 1, 2025

(30) Foreign Application Priority Data
Nov. 28, 2024 (JP) 2024-207718

(51) Int. Cl. H01S 3/032; H01S 3/038

(52) U.S. Cl. CPC H01S 3/032; H01S 3/0384

(57) ABSTRACT

A laser chamber according to an aspect of the present disclosure includes a container, a first electrode, a second electrode, and a sound absorber. The container is filled with a laser gas. The first electrode is disposed in the container. The second electrode is disposed in the container and faces the first electrode. The sound absorber is disposed on at least one of an upstream side and a downstream side of the laser gas from the first electrode. The sound absorber is configured to cause a propagation speed of an acoustic wave generated in a discharge space between the first electrode and the second electrode to decrease as a distance from the discharge space increases.

### CROSS-REFERENCE TO RELATED APPLICATIONS

The present application claims the benefit of Japanese Patent Application No. 2024-207718, filed on Nov. 28, 2024, the entire contents of which are hereby incorporated by reference.

### BACKGROUND

### 1. Technical Field

The present disclosure relates to a laser chamber, a gas laser apparatus, and an electronic device manufacturing method.

### 2. Related Art

In recent years, a semiconductor exposure apparatus is required to improve the resolution thereof as semiconductor integrated circuits are increasingly miniaturized and highly integrated. To this end, reduction in the wavelength of light emitted from a light source for exposure is underway. For example, a KrF excimer laser apparatus, which outputs laser light having a wavelength of about 248 nm, and an ArF excimer laser apparatus, which outputs laser light having a wavelength of about 193 nm, are used as a gas laser apparatus for exposure.

The light from KrF and ArF excimer laser apparatuses performing spontaneous laser oscillation has a wide spectral linewidth ranging from 350 to 400 pm. A projection lens made of a material that transmits ultraviolet light, such as the KrF and ArF laser light, therefore produces chromatic aberrations in some cases. As a result, the resolution of the projection lens may decrease. To avoid the decrease in the resolution, the spectral linewidth of the laser light output from the gas laser apparatus needs to be narrow enough to make the chromatic aberrations negligible. To this end, a line narrowing module (LNM) including a line narrowing element (such as etalon or grating) is provided in some cases in a laser resonator of the gas laser apparatus to narrow the spectral linewidth. A gas laser apparatus providing a narrowed spectral linewidth is hereinafter referred to as a narrowed-line gas laser apparatus.

### CITATION LIST

### Patent Literature

[PTL 1]JP-A-5-333865
[PTL 2]WO 2023/006931

### SUMMARY

A laser chamber according to an aspect of the present disclosure includes a container, a first electrode, a second electrode, and a sound absorber. The container is filled with a laser gas. The first electrode is disposed in the container. The second electrode is disposed in the container and faces the first electrode. The sound absorber is disposed on at least one of an upstream side and a downstream side of the laser gas from the first electrode. The sound absorber is configured to cause a propagation speed of an acoustic wave generated in a discharge space between the first electrode and the second electrode to decrease as a distance from the discharge space increases.

A gas laser apparatus according to another aspect of the present disclosure includes an optical resonator and a laser chamber. The laser chamber is so disposed that an optical path of the optical resonator passes through the laser chamber. The laser chamber includes a container, a first electrode, a second electrode, and a sound absorber. The container is filled with a laser gas. The first electrode is disposed in the container. The second electrode is disposed in the container and faces the first electrode. The sound absorber is disposed on at least one of an upstream side and a downstream side of the laser gas from the first electrode. The sound absorber is configured to cause a propagation speed of an acoustic wave generated in a discharge space between the first electrode and the second electrode to decrease as a distance from the discharge space increases.

An electronic device manufacturing method according to another aspect of the present disclosure includes: generating laser light by using a gas laser apparatus; outputting the laser light to an exposure apparatus; and exposing a photosensitive substrate to the laser light in the exposure apparatus to manufacture electronic devices. The gas laser apparatus includes an optical resonator and a laser chamber. The laser chamber is so disposed that an optical path of the optical resonator passes through the laser chamber. The laser chamber includes a container, a first electrode, a second electrode, and a sound absorber. The container is filled with a laser gas. The first electrode is disposed in the container. The second electrode is disposed in the container and faces the first electrode. The sound absorber is disposed on at least one of an upstream side and a downstream side of the laser gas from the first electrode. The sound absorber is configured to cause a propagation speed of an acoustic wave generated in a discharge space between the first electrode and the second electrode to decrease as a distance from the discharge space increases.

### BRIEF DESCRIPTION OF THE DRAWINGS

Embodiments of the present disclosure will be described below only by way of example with reference to the accompanying drawings.

FIG. 1 is a side view schematically showing the configuration of a gas laser apparatus according to Comparative Example.

FIG. 2 is a cross-sectional view schematically showing the configuration of the gas laser apparatus according to Comparative Example.

FIG. 3 is a cross-sectional view schematically showing a portion including a primary electrode in a laser chamber.

FIG. 4 diagrammatically shows the state in which an acoustic wave enters a sound absorber.

FIG. 5 diagrammatically shows the state in which the acoustic wave exits out of the sound absorber.

FIG. 6 is a cross-sectional view schematically showing the configuration of a gas laser apparatus according to an embodiment.

FIG. 7 diagrammatically shows the state in which the acoustic wave enters the sound absorber.

FIG. 8 diagrammatically shows the state in which the acoustic wave exits out of the sound absorber.

FIG. 9 shows an angle of the propagation direction of the acoustic wave exiting out of the sound absorber with respect to the propagation direction of the acoustic wave entering the sound absorber.

FIG. 10 shows definition of the dimensions of the sound absorber and the propagation speed of the acoustic wave.

FIG. 11 shows an example of the relationship between the propagation speed and compressibility.

FIG. 12 shows an example of a method for producing a sound absorber so configured that the compressibility changes.

FIG. 13 shows another example of the method for producing the sound absorber so configured that the compressibility changes.

FIG. 14 shows another example of the method for producing the sound absorber so configured that the compressibility changes.

FIG. 15 shows an example of the relationship between the propagation speed and porosity.

FIG. 16 shows an example of a method for producing a sound absorber so configured that the porosity changes.

FIG. 17 schematically shows an example of the configuration of an exposure apparatus.

### DETAILED DESCRIPTION

### <Contents>

1. Comparative Example
1.1 Configuration
1.2 Operation
1.3 Problems
2. Embodiment
2.1 Configuration
2.2 Operation
2.3 Advantages
2.4 Output angle of acoustic wave
2.5 Relationship between propagation speed and compressibility
2.6 Relationship between propagation speed and porosity
2.7 Variations
3. Electronic device manufacturing method

An embodiment of the present disclosure will be described below in detail with reference to the drawings. The embodiment described below shows some examples of the present disclosure and is not intended to limit the contents of the present disclosure. Furthermore, all configurations and operations described in the embodiment are not necessarily essential as configurations and operations in the present disclosure. Note that the same element has the same reference character, and no duplicate description of the same element will be made.

### 1. Comparative Example

Comparative Example of the present disclosure will first be described. Comparative Example of the present disclosure is an aspect that the applicant is aware of as known only by the applicant, and is not a publicly known example that the applicant is self-aware of.

### 1.1 Configuration

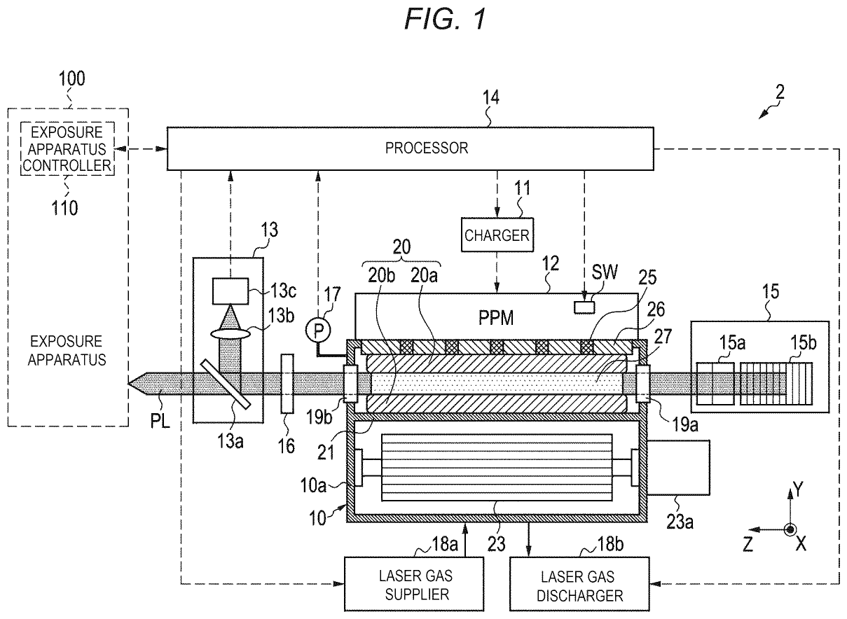

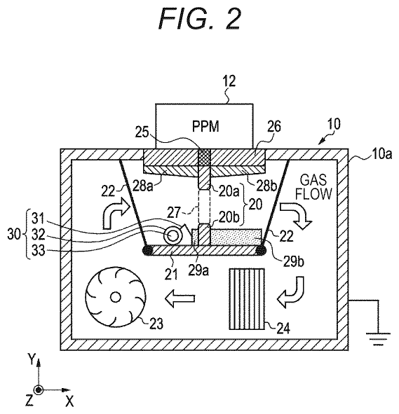

The configuration of a gas laser apparatus 2 according to Comparative Example will be described with reference to FIGS. 1 and 2. FIG. 1 schematically shows the configuration of the gas laser apparatus 2. FIG. 2 is a cross-sectional view of the gas laser apparatus 2 shown in FIG. 1 and viewed in a Z direction. The gas laser apparatus 2 is a discharge-excitation gas laser apparatus that excites a laser gas through discharge, and is, for example, an excimer laser apparatus.

It is assumed in FIG. 1 that a traveling direction of pulse laser light PL output from the gas laser apparatus 2 is the Z direction. It is further assumed that a discharge direction that will be described later is a Y direction. It is further assumed that the direction orthogonal to the Z and Y directions is an X direction. Note that the pulse laser light PL is an example of “laser light” according to the technology described in the present disclosure.

The gas laser apparatus 2 is a narrowed-line gas laser apparatus including a laser chamber 10, a charger 11, a pulse power module (PPM) 12, a pulse energy measuring unit 13, a processor 14, a pressure sensor 17, and a laser resonator. A line narrowing module 15 and an output coupling mirror 16 constitute the laser resonator.

The laser chamber 10 includes, for example, a container 10a made of aluminum metal and having a surface plated with nickel. A primary electrode 20, a ground plate 21, a return plate 22, a fan 23, a heat exchanger 24, insulating guides 28a and 28b, sound absorbers 29a and 29b, and a preliminary ionization electrode 30 are provided inside the container 10a, as shown in FIGS. 1 and 2. The preliminary ionization electrode 30 includes a preliminary ionization outer electrode 31, a dielectric pipe 32, and a preliminary ionization inner electrode 33.

A laser gas containing fluorine is encapsulated as a laser medium in the container 10a. The laser gas includes, for example, argon, krypton, xenon, or any other element as a rare gas, neon, helium, or any other element as a buffer gas, and fluorine, chlorine, or any other element as a halogen gas.

The container 10a further has an opening. An electrically insulating plate 26, in which feedthroughs 25 are embedded, is attached to the container 10a via an O-ring that is not shown so as to close the opening. The PPM 12 is disposed on the electrically insulating plate 26. The container 10a is grounded.

The PPM 12 includes a charging capacitor that is not shown and is connected to the primary electrode 20 via the feedthroughs 25. The PPM 12 includes a switch SW, which causes the primary electrode 20 to perform discharge. The charger 11 is connected to the charging capacitor of the PPM 12. The discharge that occurs at the primary electrode 20 is hereinafter referred to as primary discharge.

The primary electrode 20 includes a cathode electrode 20a and an anode electrode 20b. The cathode electrode 20a and the anode electrode 20b are so disposed that the discharge surfaces thereof face each other in the container 10a. The space between the discharge surface of the cathode electrode 20a and the discharge surface of the anode electrode 20b is called a discharge space 27. The cathode electrode 20a and the anode electrode 20b each extend in the Z direction.

The surface of the cathode electrode 20a that is opposite to the discharge surface thereof is supported by the electrically insulating plate 26, and is connected to the feedthroughs 25. That is, the cathode electrode 20a is disposed at a position closer to the inner wall of the container 10a than the anode electrode 20b with the cathode electrode 20a facing the anode electrode 20b. The surface of the anode electrode 20b that is opposite to the discharge surface thereof is supported by the ground plate 21. The cathode electrode 20a and the anode electrode 20b are examples of “first electrode and second electrode” according to the technology described in the present disclosure.

The ground plate 21 is connected to the container 10a via the return plate 22. The container 10a is grounded. The ground plate 21 is therefore grounded via the return plate 22. Ends of the ground plate 21 in the Z direction are fixed to the container 10a.

The fan 23 is a crossflow fan used to circulate the laser gas in the container 10a, and is disposed on the side of the ground plate 21 that is opposite to the discharge space 27. A motor 23a, which rotationally drives the fan 23, is connected to the container 10a.

The laser gas blown out from the fan 23 flows into the discharge space 27. A flowing direction of the laser gas flowing into the discharge space 27 is substantially parallel to the X direction. The laser gas flowing out of the discharge space 27 is suctioned into the fan 23 via the heat exchanger 24. The heat exchanger 24 changes the temperature of the laser gas by performing heat exchange between a refrigerant supplied into the heat exchanger 24 and the laser gas.

The insulating guides 28a and 28b are disposed at a surface of the electrically insulating plate 26 that is closer to the discharge space 27 so as to sandwich the cathode electrode 20a. The insulating guide 28a is disposed on the upstream side of the laser gas from the cathode electrode 20a. The insulating guide 28b is disposed on the downstream side of the laser gas from the cathode electrode 20a.

The insulating guides 28a and 28b are shaped so as to guide the flow of the laser gas so that the laser gas from the fan 23 efficiently flows between the cathode electrode 20a and the anode electrode 20b. The insulating guides 28a and 28b and the electrically insulating plate 26 are made, for example, of a ceramic material such as alumina (Al₂O₃), which has low reactivity with fluorine gas.

The sound absorbers 29a and 29b are disposed at a surface of the ground plate 21 that is closer to the discharge space 27 so as to sandwich the anode electrode 20b. The sound absorber 29a is disposed on the upstream side of the laser gas from the anode electrode 20b. The sound absorber 29b is disposed on the downstream side of the laser gas from the anode electrode 20b.

The sound absorbers 29a and 29b are made, for example, of a porous material. The porous material of which the sound absorbers 29a and 29b are made is at least one of a porous metal, a foamed metal, and a mesh metal. The materials described above are metallic materials having low reactivity with the laser gas, for example, at least one of nickel, aluminum, and copper. The sound absorbers 29a and 29b guide the laser gas from the fan 23 to flow efficiently between the cathode electrode 20a and the anode electrode 20b, and absorb an acoustic wave generated by the primary discharge.

A laser gas supplier 18a and a laser gas discharger 18b are connected to the laser chamber 10. The laser gas supplier 18a includes a valve and a flow rate control valve, and is connected to a gas cylinder containing the laser gas. The laser gas discharger 18b includes a valve and a discharge pump.

Windows 19a and 19b are provided at ends of the container 10a to cause light generated in the container 10a to exit out thereof. The laser chamber 10 is so disposed that the optical path of the optical resonator passes through the discharge space 27 and the windows 19a and 19b.

The line narrowing module 15 includes a prism 15a and a grating 15b. The prism 15a increases the beam width of the light output from the laser chamber 10 via the window 19a, and transmits the light toward the grating 15b.

The grating 15b is disposed in the Littrow arrangement, which causes the angle of incidence of the light incident on the grating 15b to be equal to the angle of diffraction of the light diffracted by the grating 15b. The grating 15b is a wavelength selection element that selectively extracts light having a specific wavelength and wavelengths in the vicinity thereof in accordance with the angle of diffraction. The light that returns from the grating 15b to the laser chamber 10 via the prism 15a has a narrowed spectral width.

The output coupling mirror 16 transmits part of the light output from the laser chamber 10 via the window 19b and reflects the other part of the light back into the laser chamber 10. The surfaces of the output coupling mirror 16 are each coated with a partially reflective film.

The light output from the laser chamber 10 travels back and forth between the line narrowing module 15 and the output coupling mirror 16 and is amplified whenever passing through the discharge space 27. Part of the amplified light is output as the pulse laser light PL via the output coupling mirror 16. The wavelength of the pulse laser light PL falls within an ultraviolet range from 150 nm to 380 nm, and is, for example, the wavelength of light from an excimer laser apparatus that performs laser oscillation.

The pulse energy measuring unit 13 is disposed in the optical path of the pulse laser light PL output via the output coupling mirror 16. The pulse energy measuring unit 13 includes a beam splitter 13a, a light collection optical system 13b, and a photosensor 13c.

The beam splitter 13a transmits the pulse laser light PL at high transmittance and reflects part of the pulse laser light PL toward the light collection optical system 13b. The light collection optical system 13b collects the light reflected off the beam splitter 13a at the light receiving surface of the photosensor 13c. The photosensor 13c measures the pulse energy of the light collected at the light receiving surface, and outputs the measured value to the processor 14.

The pressure sensor 17 detects the gas pressure in the container 10a and outputs the detected value to the processor 14. The processor 14 determines the gas pressure of the laser gas in the container 10a based on the detected value of the gas pressure and the charging voltage applied by the charger 11.

The charger 11 is a high voltage power supply that supplies the charging voltage to the charging capacitor incorporated in the PPM 12. The switch SW in the PPM 12 is controlled by the processor 14. When the switch SW is turned on from the state in which the switch SW is off, the PPM 12 generates high voltage pulses from the electrical energy stored in the charging capacitor and applies the pulses to the primary electrode 20.

The processor 14 is a CPU (central processing unit) or any other processing device that transmits and receives various signals to and from an exposure apparatus controller 110 provided in an exposure apparatus 100. For example, target pulse energy, an oscillation trigger signal, and other factors of the pulse laser light PL output to the exposure apparatus 100 are transmitted from the exposure apparatus controller 110 to the processor 14.

The processor 14 harmoniously controls the operation of each element of the gas laser apparatus 2 based on the various signals transmitted from the exposure apparatus controller 110, the measured value of the pulse energy, the detected value of the gas pressure, and other pieces of information.

Note that the gas laser apparatus 2 is not necessarily limited to a narrowed-line laser apparatus, and may instead be a laser apparatus that outputs spontaneously oscillating light. For example, the line narrowing module 15 may be replaced with a highly reflective mirror.

### 1.2 Operation

The operation of the gas laser apparatus 2 according to Comparative Example will next be described. The processor 14 first controls the laser gas supplier 18a to cause it to supply the laser gas into the container 10a of the laser chamber 10, and drives the motor 23a to rotate the fan 23. The laser gas filled in the container 10a thus circulates, as indicated by the arrows in FIG. 2.

The processor 14 receives the target pulse energy and the oscillation trigger signal transmitted from the exposure apparatus controller 110. Note that the oscillation trigger signal is a signal that instructs the gas laser apparatus 2 to output the pulse laser light PL corresponding to one pulse.

The processor 14 sets a charging voltage corresponding to the target pulse energy in the charger 11. The processor 14 operates the switch SW in the PPM 12 in synchronization with the oscillation trigger signal.

When the switch SW in the PPM 12 is turned on from the state in which the switch SW is off, the voltage is applied to the space between the preliminary ionization inner electrode 33 and the preliminary ionization outer electrode 31 of the preliminary ionization electrode 30, and to the space between the cathode electrode 20a and the anode electrode 20b. Corona discharge thus occurs at the preliminary ionization electrode 30, and UV (ultraviolet) light is generated. Irradiating the laser gas in the discharge space 27 with the UV light preliminarily ionizes the laser gas.

Thereafter, when the voltage between the cathode electrode 20a and the anode electrode 20b reaches the dielectric breakdown voltage, the primary discharge occurs in the discharge space 27. Assuming that the discharge direction of the primary discharge is the direction in which the electrons flow, the discharge direction is the direction from the cathode electrode 20a toward the anode electrode 20b. When the primary discharge occurs, the laser gas in the discharge space 27 is excited and emits light.

The light emitted from the laser gas is reflected off the line narrowing module 15 and the output coupling mirror 16 and travels back and forth in the laser resonator, so that laser oscillation occurs. The light having a bandwidth narrowed by the line narrowing module 15 is output as the pulse laser light PL via the output coupling mirror 16.

Part of the pulse laser light PL output via the output coupling mirror 16 enters the pulse energy measuring unit 13. The pulse energy measuring unit 13 measures the pulse energy of the incident pulse laser light PL, and outputs the measured value to the processor 14.

The processor 14 calculates a difference ΔE between the measured pulse energy and the target pulse energy. The processor 14 performs feedback control on the charging voltage in such a way that the difference ΔE approaches zero.

The processor 14 controls the laser gas supplier 18a to cause it to supply the laser gas into the container 10a until a predetermined pressure is reached when the charging voltage becomes higher than the maximum value of an allowable range. The processor 14 controls the laser gas discharger 18b to cause it to discharge the laser gas from the container 10a until the predetermined pressure is reached when the charging voltage becomes lower than the minimum value of the allowable range.

The pulse laser light PL having passed through the pulse energy measuring unit 13 enters the exposure apparatus 100.

Note that discharge products are generated in the container 10a by the primary discharge in the discharge space 27. The generated discharge products are moved away from the discharge space 27 by the gas flow generated by the fan 23. The discharge is thus stabilized. Furthermore, the temperature of the laser gas increases due to the primary discharge. The laser gas having the increased temperature is cooled by cooling water flowing in the heat exchanger 24 in the course of passing through the heat exchanger 24.

Furthermore, the primary discharge at the cathode electrode 20a and the anode electrode 20b generates the acoustic wave. The generated acoustic wave is attenuated when absorbed by the sound absorbers 29a and 29b.

### 1.3 Problems

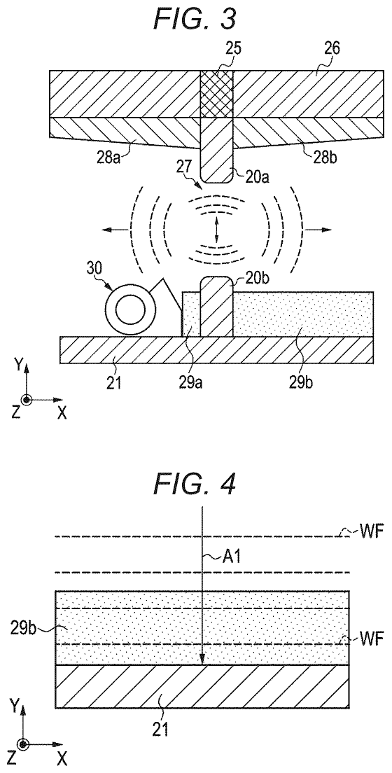

FIG. 3 schematically shows a portion including the primary electrode 20 in the laser chamber 10 according to Comparative Example. The broken lines shown in FIG. 3 diagrammatically show the acoustic wave generated by the primary discharge. As shown in FIG. 3, the acoustic wave generated by the primary discharge is a compressional wave of the laser gas and propagates while spreading from the discharge space 27. The acoustic wave may, at the timing when the primary discharge occurs next, remain in the discharge space 27 or be reflected off a structure in the container 10a and may return to the discharge space 27. Primary discharge that occurs when the acoustic wave in the discharge space 27 is not attenuated as described above may adversely affect the laser performance such as the spectral linewidth of the pulse laser light PL.

In the gas laser apparatus 2 according to Comparative Example, the sound absorbers 29a and 29b are provided to attenuate the acoustic wave in the discharge space 27. However, part of the acoustic wave may return from the sound absorbers 29a and 29b into the discharge space 27, and hinder the attenuation of the acoustic wave in the discharge space 27.

FIG. 4 diagrammatically shows the state in which the acoustic wave enters the sound absorber 29b. A reference character A1 represents a propagation direction of the acoustic wave that enters the sound absorber 29b. A reference character WF represents the wave front of the acoustic wave. For example, the acoustic wave is incident as a plane wave on the surface of the sound absorber 29b at right angles, as shown in FIG. 4. The acoustic wave propagates in the sound absorber 29b at a uniform speed, so that the acoustic wave having entered the sound absorber 29b propagates in the sound absorber 29b with no phase difference produced and is reflected off the ground plate 21.

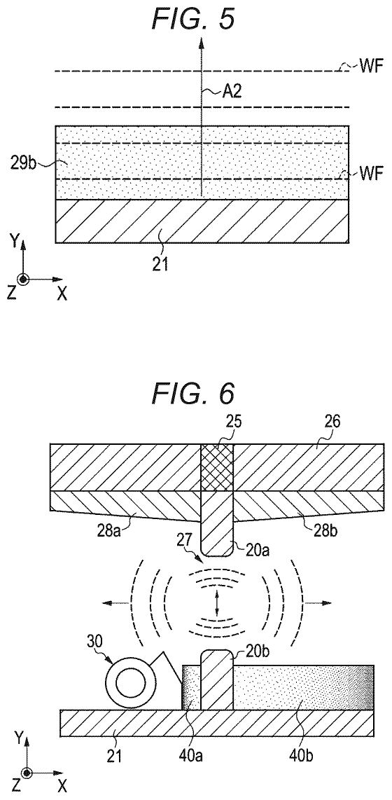

FIG. 5 diagrammatically shows the state in which the acoustic wave exits out of the sound absorber 29b. A reference character A2 represents the propagation direction of the acoustic wave that exits out of the sound absorber 29b. The acoustic wave reflected off the ground plate 21 propagates in the sound absorber 29b with no phase difference produced, and exits in the direction perpendicular to the surface of the sound absorber 29b. As described above, since the acoustic wave exits in the direction perpendicular to the surface of the sound absorber 29b, part of the acoustic wave returns into the discharge space 27 to hinder the attenuation of the acoustic wave.

FIGS. 4 and 5 show the state in which the acoustic wave enters and exits out of the sound absorber 29b, and the same holds true for the sound absorber 29a.

In particular, the higher the repetition frequency of the pulse laser light PL, the more insufficient the attenuation of the acoustic wave in the discharge space 27 until the timing of the subsequent primary discharge, so that the laser performance deteriorates.

To solve the problem described above, an object of the present disclosure is to enhance the laser performance by attenuating the acoustic wave in the discharge space 27 early.

### 2. Embodiment

### 2.1 Configuration

A gas laser apparatus 2 according to an embodiment of the present disclosure is configured in the same manner as the gas laser apparatus 2 according to Comparative Example except a different configuration in the laser chamber 10.

FIG. 6 schematically shows a portion including the primary electrode 20 in the laser chamber 10 according to the embodiment. The broken lines shown in FIG. 6 diagrammatically show the acoustic wave generated by the primary discharge. In the present embodiment, sound absorbers 40a and 40b are provided in place of the sound absorbers 29a and 29b. The sound absorbers 40a and 40b are disposed at a surface of the ground plate 21 that is closer to the discharge space 27 so as to sandwich the anode electrode 20b, as in Comparative Example.

The sound absorbers 40a and 40b are made, for example, of a porous material, as in Comparative Example. The material of which the sound absorbers 40a and 40b are made is at least one of a porous metal, a foamed metal, and a mesh metal. The materials described above are metallic materials having low reactivity with the laser gas, for example, at least one of nickel, aluminum, and copper.

In the present embodiment, the sound absorbers 40a and 40b are so configured that the propagation speed of the acoustic wave continuously changes in the X direction, which is a direction perpendicular to the discharge direction. Specifically, in the sound absorbers 40a and 40b, the propagation speed of the acoustic wave decreases as the distance from the discharge space 27 increases. In the sound absorber 40a, the sound wave propagates at a lower speed on the upstream side of the laser gas than on the downstream side of the laser gas. In the sound absorber 40b, the sound wave propagates at a lower speed on the downstream side of the laser gas than on the upstream side of the laser gas.

The propagation speed of the acoustic wave in the sound absorbers 40a and 40b can be changed by changing the compressibility of the sound absorbers 40a and 40b. This is because the porosity in the sound absorbers 40a and 40b changes in accordance with the compressibility. The greater the compressibility, the smaller the porosity and the lower the propagation speed of the acoustic wave.

The propagation speed of the acoustic wave in the sound absorbers 40a and 40b can also be changed by changing the porosity of multiple cell structures contained in the sound absorbers 40a and 40b. The smaller the porosity, the lower the propagation speed of the acoustic wave. Changing the porosity corresponds to changing the density.

Note that the propagation speed of the acoustic wave can also be changed by changing the elastic modulus in the sound absorbers 40a and 40b. The smaller the elastic modulus, the lower the propagation speed of the acoustic wave.

### 2.2 Operation

The operation of the gas laser apparatus 2 according to the present embodiment is the same as that in Comparative Example except that the sound absorbers 40a and 40b attenuate the acoustic wave differently.

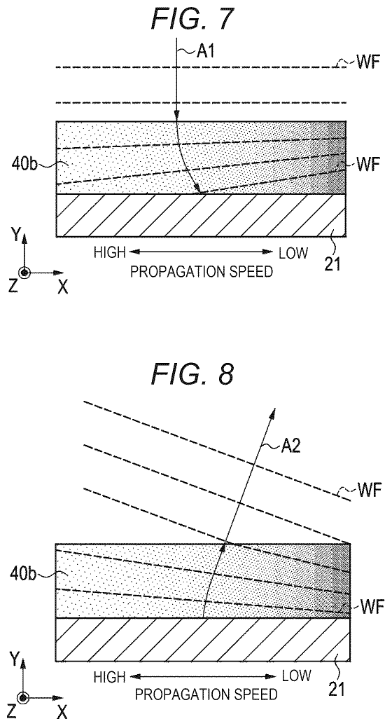

FIG. 7 diagrammatically shows the state in which the acoustic wave enters the sound absorber 40b. The reference character A1 represents the propagation direction of the acoustic wave that enters the sound absorber 40b. For example, the acoustic wave is incident as a plane wave on the surface of the sound absorber 40b at right angles, as shown in FIG. 7. In the present embodiment, since the propagation speed of the acoustic wave in the sound absorber 40b decreases as the distance from the discharge space 27 increases, the acoustic wave entering the sound absorber 40b propagates with a phase difference produced in the sound absorber 40b while the wave front WF inclines, and is reflected off the ground plate 21.

FIG. 8 diagrammatically shows the state in which the acoustic wave exits out of the sound absorber 40b. The reference character A2 represents the propagation direction of the acoustic wave that exits out of the sound absorber 40b. The acoustic wave reflected off the ground plate 21 propagates in the sound absorber 40b with a phase difference produced while the wave front WF inclines, and exits via the surface of the sound absorber 40b. As described above, in the present embodiment, the acoustic wave exiting out of the sound absorber 40b obliquely propagates in a direction away from the discharge space 27.

FIGS. 7 and 8 and subsequent figures will be described with reference to the sound absorber 40b, and the same holds true for the sound absorber 40a. That is, the acoustic wave exiting out of the sound absorber 40a obliquely propagates in a direction away from the discharge space 27.

### 2.3 Advantages

In the present embodiment, the acoustic wave that enters and exits out of the sound absorbers 40a and 40b obliquely propagates in a direction away from the discharge space 27, preventing the acoustic wave from returning to the discharge space 27. The acoustic wave in the discharge space 27 can therefore be attenuated early, so that the laser performance can be improved.

As described above, according to the present embodiment, since the acoustic wave in the discharge space 27 can be attenuated early, the laser performance can be enhanced even at a high repetition frequency, for example, higher than or equal to 6 kHz.

### 2.4 Output Angle of Acoustic Wave

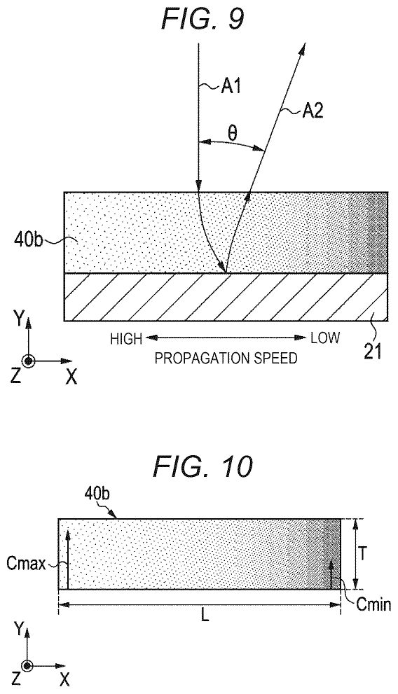

The output angle of the acoustic wave output from the sound absorbers 40a and 40b will next be described. FIG. 9 shows an angle θ of the propagation direction A2 of the acoustic wave output from the sound absorber 40b with respect to the propagation direction A1 of the acoustic wave entering the sound absorber 40b. The angle θ represents the angle at which the acoustic wave having entered the sound absorber 40b exits out of the sound absorber 40b.

Let T be the length of the sound absorber 40b in the Y direction, L be the length of the sound absorber 40b in the X direction, Cmax be the maximum propagation speed of the acoustic wave in the sound absorber 40b, and Cmin be the minimum propagation speed of the acoustic wave in the sound absorber 40b as shown in FIG. 10, and the angle θ is calculated by Expression (1) below. Note that the acoustic wave has a component that propagates in the X direction as well as in the Y direction, but the propagation speed of the acoustic wave in the sound absorber 40b is defined by the propagation speed in the Y direction.

$$tan θ = \frac{2 T}{L} ( \frac{Cmax}{Cmin} - 1 ) \qquad ( 1 )$$

The angle θ calculated by Expression (1) described above corresponds to the inclination angle of the wave front WF caused by the propagation of the sound wave in the sound absorber 40b. The length T in the Y direction is hereinafter referred to as a thickness T.

To attenuate the acoustic wave in the discharge space 27 early, the angle θ is preferably greater than or equal to 20° but smaller than 90°, and more preferably, 45°. The thickness T of the sound absorber 40b is preferably greater than or equal to 3 mm but smaller than or equal to 10 mm. The same holds true for the sound absorber 40a.

### 2.5 Relationship Between Propagation Speed and Compressibility

When the sound absorbers 40a and 40b are so configured that the compressibility changes, the angle θ described above can be determined based on the compressibility.

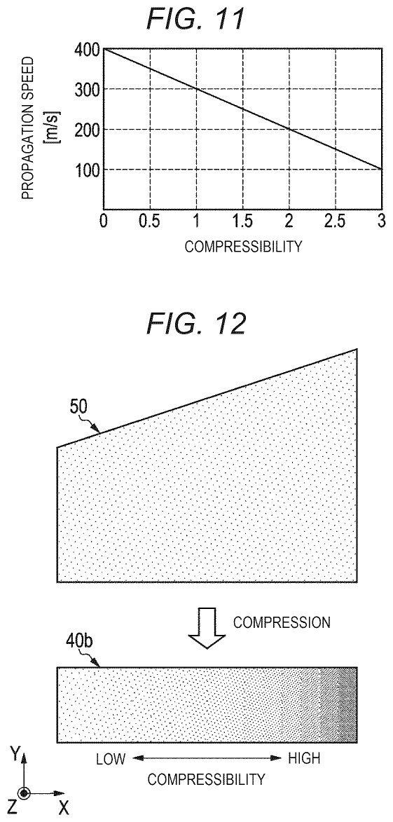

FIG. 11 shows an example of the relationship between the propagation speed and the compressibility. The higher the compressibility, the lower the propagation speed. To set θ=45° when T=5 mm and L=20 mm, Cmax/Cmin in Expression (1) described above may be set at three. In the example shown in FIG. 11, for each of the sound absorbers 40a and 40b, Cmax/Cmin can be set at three by setting the compressibility at an end closer to the discharge space 27 at one and the compressibility at an end farther from the discharge space 27 at three. The compressibility of one indicates an uncompressed state.

FIG. 12 shows an example of a method for producing the sound absorber 40b so configured that the compressibility changes. A trapezoidal sound absorber 50 having a continuously changing thickness is first produced. The sound absorber 50 is then compressed so as to have a uniform thickness. As a result, the sound absorber 40b in which the compressibility continuously changes and the propagation speed of the acoustic wave continuously changes is produced. The difference in thickness of the sound absorber 50 before the compression allows the angle θ described above to be set at a desired value.

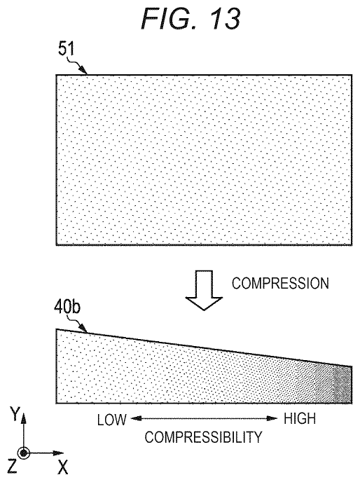

FIG. 13 shows another example of the method for producing the sound absorber 40b so configured that the compressibility changes. A rectangular sound absorber 51 having a uniform thickness is first produced. The sound absorber 51 is then compressed so as to have a continuously varying thickness. As a result, the sound absorber 40b in which the compressibility continuously changes and the propagation speed of the acoustic wave continuously changes is produced. The difference in thickness of the sound absorber 40b after the compression allows the angle θ described above to be set at a desired value. In this case, the sound absorber 40b has a trapezoidal shape.

In the method shown in FIG. 12, since the sound absorber 50 before the compression has a trapezoidal shape, it takes a longer period and requires more effort to produce the sound absorber 50 before the compression than in the method shown in FIG. 13, but the sound absorber only needs to be so compressed that the thickness becomes uniform, so that the process involving the compression is readily carried out.

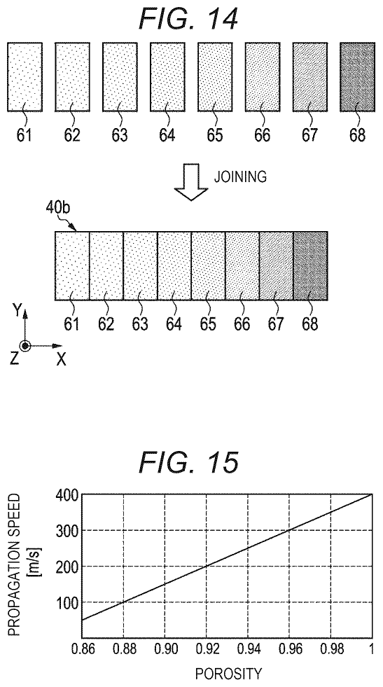

FIG. 14 shows another example of the method for producing the sound absorber 40b so configured that the compressibility changes. Multiple divided sound absorbers 61 to 68 each having compressibility different from those of the others are first produced. The divided sound absorber 61 has the lowest compressibility, and the divided sound absorber 68 has the highest compressibility. The multiple divided sound absorbers 61 to 68 are then so arranged and joined to each other that the compressibility sequentially changes. As a result, the sound absorber 40b in which the compressibility changes is produced. In this case, in the sound absorber 40b, the compressibility changes stepwise, and the propagation speed of the sound wave changes stepwise. The difference in compressibility between the divided sound absorber 61 and the divided sound absorber 68 allows the angle θ described above to be set at a desired value.

In the example shown in FIG. 14, eight divided sound absorbers are used to form one sound absorber, but the number of the divided sound absorbers is not limited to a specific number and only needs to be two or more. The divided sound absorbers mean a small unit of absorbers that form a single sound absorber in which the propagation speed of the acoustic wave changes.

### 2.6 Relationship Between Propagation Speed and Porosity

When the sound absorbers 40a and 40b are so configured that the porosity changes, the angle θ described above can be determined based on the porosity.

FIG. 15 shows an example of the relationship between the propagation speed and the porosity. The higher the porosity, the higher the propagation speed. To set θ=450 when T=5 mm and L=20 mm, Cmax/Cmin in Expression (1) described above may be set at three. In the example shown in FIG. 15, for each of the sound absorbers 40a and 40b, Cmax/Cmin can be set at three by setting the porosity at an end closer to the discharge space 27 at 0.96 and the porosity at an end farther from the discharge space 27 at 0.88. A porosity of 1 indicates that the entire sound absorber is configured with a pore.

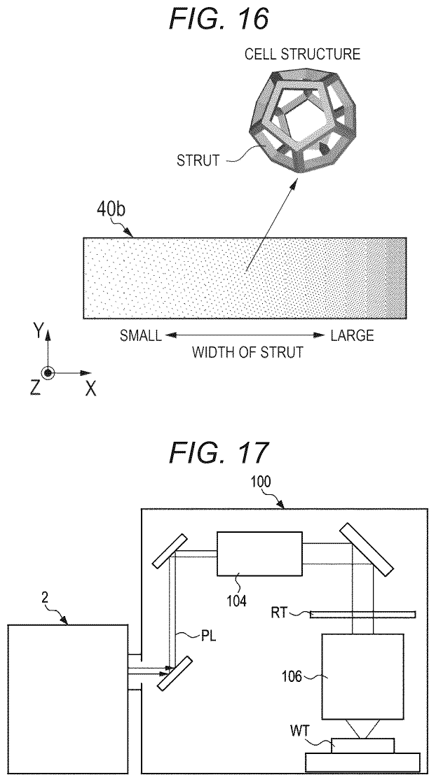

FIG. 16 shows an example of a method for producing the sound absorber 40b so configured that the porosity changes. The sound absorber 40b is an aggregate of cell structures each having a pore, as shown in FIG. 16. The cell structures are each configured by joining multiple struts to each other. The porosity can be changed by changing the width of each of the struts. The larger the width of each of the struts, the smaller the porosity. Therefore, by gradually increasing the width of each of the struts as the distance from the discharge space 27 increases, the sound absorber 40b in which the porosity continuously changes and the propagation speed of the acoustic wave changes is produced.

### 2.7 Variations

In the embodiment described above, the sound absorbers 40a and 40b are provided so as to sandwich the anode electrode 20b, but only one of the sound absorbers 40a and 40b may instead be provided. That is, the sound absorber according to the embodiment described above only needs to be provided on at least one of the upstream side of the laser gas from the anode electrode 20b and the downstream side of the laser gas therefrom.

Furthermore, in the embodiment described above, the sound absorbers 40a and 40b are provided at the ground plate 21, which supports the anode electrode 20b, but similar sound absorbing members may instead be provided at the electrically insulating plate 26, which supports the cathode electrode 20a. That is, the sound absorbers according to the embodiment described above may be provided in place of the insulating guides 28a and 28b. Note in this case that it is preferable to provide insulating sound absorbers. The acoustic wave in the discharge space 27 can thus be attenuated earlier.

### 3. Electronic Device Manufacturing Method

FIG. 17 schematically shows an example of the configuration of the exposure apparatus 100. The exposure apparatus 100 includes an illumination optical system 104 and a projection optical system 106. The illumination optical system 104 illuminates a reticle pattern of a reticle that is not shown but is placed on a reticle stage RT, for example, with the pulse laser light PL having entered the illumination optical system 104 from the gas laser apparatus 2. The projection optical system 106 performs reduction projection on the pulse laser light PL having passed through the reticle to bring the pulse laser light PL into focus at a workpiece that is not shown but is placed on a workpiece table WT. The workpiece is a photosensitive substrate onto which a photoresist has been applied, such as a semiconductor wafer.

The exposure apparatus 100 synchronously translates the reticle stage RT and the workpiece table WT to expose the workpiece to the pulse laser light PL having reflected the reticle pattern. Semiconductor devices can be manufactured by transferring the reticle pattern onto the semiconductor wafer in the exposure step described above and then carrying out multiple other steps. The semiconductor devices are an example of the “electronic devices” in the present disclosure.

Note that the gas laser apparatus 2 does not necessarily manufacture electronic devices, and can also be used to perform laser processing such as drilling.

The description above is intended to be illustrative and the present disclosure is not limited thereto. Therefore, it would be obvious to those skilled in the art that various modifications to the embodiments of the present disclosure would be possible without departing from the spirit and the scope of the appended claims.

The terms used throughout the present specification and the appended claims should be interpreted as non-limiting terms. For example, terms such as “comprise”, “include”, “have”, and “contain” should not be interpreted to be exclusive of other structural elements. Further, indefinite articles “a/an” described in the present specification and the appended claims should be interpreted to mean “at least one” or “one or more”. Further, “at least one of A, B, and C” should be interpreted to mean any of A, B, C, A+B, A+C, B+C, and A+B+C as well as to include combinations of any thereof and any other than A, B, and C.

What is claimed is:

1. A laser chamber comprising:
a container filled with a laser gas;
a first electrode disposed in the container;
a second electrode disposed in the container and facing the first electrode; and
a sound absorber disposed on at least one of an upstream side and a downstream side of the laser gas from the first electrode, and configured to cause a propagation speed of an acoustic wave generated in a discharge space between the first electrode and the second electrode to decrease as a distance from the discharge space increases.

2. The laser chamber according to claim 1, wherein
the second electrode is disposed at a position closer to an inner wall of the container than the first electrode.

3. The laser chamber according to claim 1, wherein
in the sound absorber, the propagation speed is changed by changing compressibility.

4. The laser chamber according to claim 3, wherein
the sound absorber is formed by arranging multiple divided sound absorbers each having compressibility different from compressibility of the others and joining the divided sound absorbers to each other.

5. The laser chamber according to claim 1, wherein
in the sound absorber, the propagation speed is changed by changing porosity.

6. The laser chamber according to claim 5, wherein
the sound absorber is an aggregate of cell structures each having a pore, and
the porosity is changed by changing a width of each strut of each of the cell structures.

7. The laser chamber according to claim 1, wherein
in the sound absorber, the propagation speed is changed by changing density.

8. The laser chamber according to claim 1, wherein
the propagation speed continuously changes as the distance from the discharge space increases.

9. The laser chamber according to claim 1, wherein
an angle at which the acoustic wave entering the sound absorber exits out of the sound absorber is greater than or equal to 20° but smaller than 90°.

10. The laser chamber according to claim 1, wherein
a thickness of the sound absorber in a discharge direction is greater than or equal to 3 mm but smaller than or equal to 10 mm.

11. A gas laser apparatus comprising: an optical resonator; and a laser chamber so disposed that an optical path of the optical resonator passes through the laser chamber, the laser chamber including
a container filled with a laser gas,
a first electrode disposed in the container,
a second electrode disposed in the container and facing the first electrode, and
a sound absorber disposed on at least one of an upstream side and a downstream side of the laser gas from the first electrode, and configured to cause a propagation speed of an acoustic wave generated in a discharge space between the first electrode and the second electrode to decrease as a distance from the discharge space increases.

12. The gas laser apparatus according to claim 11, wherein
the second electrode is disposed at a position closer to an inner wall of the container than the first electrode.

13. The gas laser apparatus according to claim 11, wherein
in the sound absorber, changing compressibility changes the propagation speed.

14. The gas laser apparatus according to claim 13, wherein
the sound absorber is formed by arranging multiple divided sound absorbers each having compressibility different from compressibility of the others and joining the divided sound absorbers to each other.

15. The gas laser apparatus according to claim 11, wherein
in the sound absorber, changing porosity changes the propagation speed.

16. The gas laser apparatus according to claim 15, wherein
the sound absorber is an aggregate of cell structures each having a pore, and
the porosity is changed by changing a width of each strut of each of the cell structures.

17. The gas laser apparatus according to claim 11, wherein
in the sound absorber, changing density changes the propagation speed.

18. The gas laser apparatus according to claim 11, wherein
the propagation speed continuously changes as the distance from the discharge space increases.

19. The gas laser apparatus according to claim 11, wherein
an angle at which the acoustic wave entering the sound absorber exits out of the sound absorber is greater than or equal to 20° but smaller than 90°.

20. An electronic device manufacturing method, comprising:
generating laser light by using a gas laser apparatus;
outputting the laser light to an exposure apparatus; and
exposing a photosensitive substrate to the laser light in the exposure apparatus to manufacture electronic devices,
the gas laser apparatus including an optical resonator, and a laser chamber so disposed that an optical path of the optical resonator passes through the laser chamber,
the laser chamber including
a container filled with a laser gas,
a first electrode disposed in the container,
a second electrode disposed in the container and facing the first electrode, and
a sound absorber disposed on at least one of an upstream side and a downstream side of the laser gas from the first electrode, and configured to cause a propagation speed of an acoustic wave generated in a discharge space between the first electrode and the second electrode to decrease as a distance from the discharge space increases.
